(19) United States
(12) Patent Application Publication
(10) Pub. No.: US 2007/0092001 A1
(43) Pub. Date: Apr. 26, 2007

(54) Moving picture coding apparatus, method and computer program

(76) Inventor: Hiroshi Arakawa, Nara (JP)

Correspondence Address: WENDEROTH, LIND & PONACK L.L.P., 2033 K. STREET, NW, SUITE 800, WASHINGTON, DC, 20006, US

(21) Appl. No.: 11/582,485

(22) Filed: Oct. 18, 2006

(30) Foreign Application Priority Data
Oct. 21, 2005 (JP) 2005-307839

(51) Int. Cl. H04N 11/04; H04N 7/12

(52) U.S. Cl. 375/240.03; 375/240.26

(57) ABSTRACT

A moving picture coding apparatus which codes a moving picture and includes a first extraction unit, which extracts a feature quantity of luminance components of the moving picture, a second extraction unit which extracts a feature quantity of chrominance components of the moving picture, a control unit which controls the quantization width for the chrominance components based on the feature quantity of the luminance components and the feature quantity of the chrominance components.

### BACKGROUND

(1) Field of the Invention

The present invention relates to a moving picture coding apparatus which codes a moving picture, and in particular to a moving picture coding apparatus which utilizes inter-frame coding technology.

(2) Description of the Related Art

In recent years, as the digitalization of AV data has progressed, equipment capable of digitalizing moving picture signals and handling the digitalized data has grown in popularity. Since moving picture signals have enormous data loads, generally these signals are coded by continuously reducing data loads with attention to recording capacity and transmission efficiency. The international standards developed by the MPEG (Moving Picture Experts Group) working group are widely used as a coding technology for moving picture signals.

With MPEG, the motion vectors for the moving picture's luminance and the motion vectors for the moving picture's chrominance are generally handled in common. In other words, configurations are realized in which only motion vectors for luminance, which is an important visual characteristic for humans, are estimated, and the motion vectors for luminance are applied as the motion vectors for chrominance.

In this way, since there is no need to include a circuit that estimates motion vectors for chrominance, circuit sizes can be reduced. However, there are cases where frames, in which luminance is smooth and chrominance has variations, are successive, and in these cases there is the problem that phenomena, in which the hue of the moving picture distorts, occur (below, “color distortion”).

FIG. 1 is a diagram which shows an example of a frame 800 which has a smooth luminance and a chrominance with variations. This frame 800 is made up of luminance components 801, and chrominance components 802 in which the hue of the section corresponding to the letter “A” differs from the background hue; where the luminance components 801 are uniform for the whole frame. Since the motion vector for the luminance of the frame 800 is 0, in the case where the motion vector for the luminance is applied as a motion vector for the chrominance, a macroblock is generated for which a motion prediction will be completely inaccurate.

FIG. 2 is a figure which shows that the motion prediction for the chrominance is completely inaccurate. Here, a P frame 903 is coded using an I frame 900 as a reference frame, and a P frame 906 is coded using the P frame 903 as a reference frame. Also, the letter “A” drawn in the chrominance moves from left to right with the passage of time.

When the luminances of the I frame 900 and of the P frame 903 are assumed to be smooth, the luminance in a macroblock 904 of the P frame 903 and the luminance in a macroblock 901 of the I frame 900 are also smooth; the macroblock 901 being a reference macroblock for the macroblock 904. As a result, since the motion vector for the macroblock 904 reaches 0, the macroblock 901 becomes a reference macroblock for the macroblock 904. Since the motion vectors of the luminance and chrominance are common, the reference macroblock for the chrominance macroblock 905, to be coded, will be a macroblock 902 co-located with the luminance MB 901. However, when the coded macroblock 905 and the reference macroblock 902 are compared, the correlation is weak and the motion prediction is divergent. In the same way, the macroblock 904 is a reference macroblock for a luminance macroblock 907, to be coded, of the P frame 906, and when the macroblock 905 is the reference macroblock for a chrominance coding macroblock 908, the motion prediction for the chrominance diverges in the same way as the coding of the P frame 903. In this way, the residual components for the chrominance become larger when the motion prediction diverges. When the residual components for the chrominance increase, the quantization error for the chrominance grows and becomes a cause of color distortion.

Consequently there is technology which selects intra-frame coding when color distortion seems likely to occur (see for example Patent Document 1, Japanese Laid-Open Patent Application No. 2003-037844 Publication (Paragraph [0017], FIG. 16)). Since this technology does not estimate motion vectors, the problem of color distortion can be avoided without the motion prediction for the chrominance diverging.

In addition, there is technology for estimating not only a motion vector for the luminance, but also estimating a motion vector for the chrominance (see for example Patent Document 2, Japanese Translation of PCT International Application laid open as JP2001-517879 Publication). Since this technology estimates not only the motion vector for the luminance, but also the motion vector for the chrominance, the problem of color distortion can be avoided without the motion prediction for the chrominance diverging.

However, according to the technology disclosed in the Patent Document 1, when color distortion seems likely to occur, there is the problem that the coding efficiency will drop because intra-frame coding is chosen. In other words, although the coding for the luminance may be carried out by motion prediction with few residual components, since the luminance is smooth when color distortion seems likely to occur, the coding efficiency will drop since intra-frame coding is selected.

Also, according to the technology disclosed in the Patent Document 2, the circuit size necessary for motion estimation increases as the transfer load of pixel value data expands, since the pixel values necessary for motion estimation are not just the pixel values of the luminance components, but also of the chrominance components. Particularly, the increase in the transfer load for pixel value data strains the memory bandwidth, which results in having to increase the process clock and causing power consumption to increase. Also, motion estimation for the chrominance components will often fail since noise and aliasing distortion abound in the inputted moving picture. In order to solve this problem, filtering should be conducted; however in that case the circuit size will further expand.

### SUMMARY

The present invention is realized in consideration of the aforementioned kinds of problems and has an object of providing a moving picture coding apparatus capable of easily avoiding the problem of color distortion.

In order to achieve the object above, the moving picture coding apparatus in the present invention is a moving picture coding apparatus which codes a moving picture, and includes: a first extraction unit which extracts a feature quantity of luminance components of the moving picture; a second extraction unit which extracts a feature quantity of chrominance components of the moving picture; a first comparison unit which compares the extracted feature quantity of the luminance components with a first reference value; a second comparison unit which compares the extracted feature quantity of the chrominance components with a second reference value; a modification unit which modifies a quantization width for the chrominance components based on the comparison by the first comparison unit and the comparison by the second comparison unit; and a quantization unit which quantizes information related to the moving picture utilizing the modified quantization width. With this, the problem of color distortion can be avoided since when color distortion occurs, the quantization width for the chrominance elements decreases, and the quantization error will also decrease.

For example, the modification unit diminishes the quantization width for the chrominance components to less than a predetermined quantization width when the feature quantity of the luminance components is smaller than the first reference value and the feature quantity of the chrominance components is larger than the second reference value. The feature quantity of the luminance components is one of a variance of luminance in pixels which compose the moving picture and a sum of absolute differences of variances from an average luminance in the pixels which compose the moving picture. The feature quantity of the chrominance components is one of a variance of chrominance in pixels which compose the moving picture and a sum of absolute differences of variances from an average chrominance in the pixels which compose the moving picture. The first reference value is a value which indicates that the luminance of the moving picture is smooth, and the second reference value indicates that there are variations in the chrominance of the moving picture. The predetermined quantization width is a default value prescribed in the H.264 standard. With this, it is detected that the luminance is flat, based on the variance of the luminance and so on, and when it is detected that there are variations in the chrominance based on the variance of the chrominance and so on, the quantization width decreases to less than the default value. As a result, the problem of color distortion can be avoided since the quantization error decreases.

Here, the modification unit may diminish the quantization width for the chrominance components to less than a predetermined quantization width when the feature quantity of the luminance components for a plurality of successive pictures is smaller than the first reference value and the feature quantity of the chrominance components for a plurality of successive pictures is larger than the second reference value. With this, the frequency at which the quantization width is changed can be reduced since the quantization width for each of a series of pictures is controlled.

The modification unit may also diminish the quantization width for the chrominance components to less than a predetermined quantization width when the moving picture is one of an I picture and a P picture. For a B picture, the modification unit can use the quantization width for an immediately preceding I picture or P picture.

Also, the first extraction unit may extract the feature quantity of the luminance components for each area that composes the moving picture, the second extraction unit may extract the feature quantity of the chrominance components for each small area which composes the moving picture, and the modification unit may modify the quantization width for each small area. With this, it becomes possible to modify the quantization width for each macroblock or slice.

Note that the present invention can be realized not only as the moving picture coding apparatus above but also as a moving picture coding method which includes the characteristic units included in the moving picture coding apparatus as steps, and as a program which causes a computer to execute these steps. It goes without saying that this sort of program could be distributed through a recording medium such as a CD-ROM and a transmission medium such as the Internet.

Also, the block diagrams (FIG. 3 to FIG. 5) are realized typically as an LSI, which is an integrated circuit. Each of these parts can be in plural single-function LSIs, or also can be in one integrated LSI so as to include a part or all of these parts. The name used here is LSI, but it may also be called IC, system LSI, super LSI, or ultra LSI depending on the degree of integration.

Moreover, ways to achieve integration are not limited to the LSI, and a special circuit or a general purpose processor and so forth can also achieve the integration. A Field Programmable Gate Array (FPGA) that can be programmed after manufacturing LSI or a reconfigurable processor that allows reconfiguration of the connection or configuration of LSI may be used for the same purpose.

In the future, with advancement in semiconductor technology, a brand-new technology may replace LSI. The integration can be carried out by that technology. Application of biotechnology is one such possibility.

According to the moving picture coding apparatus in the present invention, the problem of color distortion can be easily avoided.

For example, by adding a simple circuit which computes the variance of the luminance and the variance of the chrominance, it is possible to detect when color distortion occurs. Therefore there is no longer a need to add a complicated circuit conventionally necessary for motion estimation, and the problems of strain on the memory bandwidth and of increases in the consumption of electric power are solved.

In addition, the moving picture coding apparatus in the present invention avoids the problem of color distortion by modifying (by, for example, diminishing) the quantization width for the chrominance elements. Accordingly, since there is no longer a need to use intra-frame coding as in the past, the problem where coding efficiency drops does not occur.

The disclosure of Japanese Patent Application No. 2005-307839 filed on Oct. 21, 2005 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a figure which shows an example of a frame in which the luminance is smooth and the chrominance has variations;

FIG. 2 is a figure which shows that the motion prediction for the chrominance is completely inaccurate;

FIG. 3 is a block diagram of a moving picture coding apparatus in the first embodiment of the present invention;

FIG. 4 is a block diagram of one unit of the moving picture coding apparatus in the first embodiment of the present invention;

FIG. 5 is a block diagram of one unit of the moving picture coding apparatus in the first embodiment of the present invention;

FIG. 6A is a schematic diagram of a feature quantity;

FIG. 6B is a schematic diagram of the feature quantity;

FIG. 7 is a flowchart of the moving picture coding apparatus in the first embodiment of the present invention;

FIG. 8 is a diagram which shows that quantization widths for two types of chrominance components are separately controlled;

FIG. 9A is a figure which shows the effect of the moving picture coding apparatus in the first embodiment of the present invention;

FIG. 9B is a figure which shows the effect of the moving picture coding apparatus in the first embodiment of the present invention; and

FIG. 10 is a flowchart in the second embodiment of the present invention.

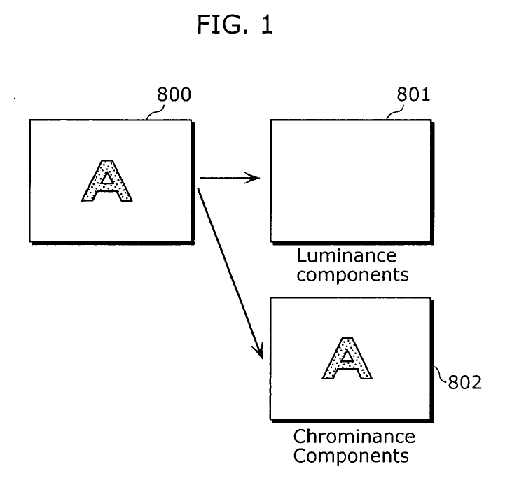

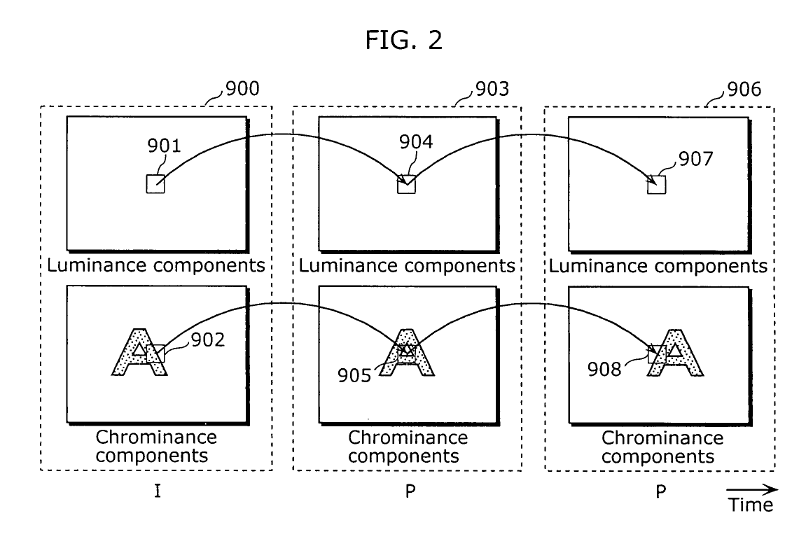

### DESCRIPTION OF THE PREFERRED EMBODIMENTS

Below, the embodiments of the present invention are described in detail using figures.

### First Embodiment

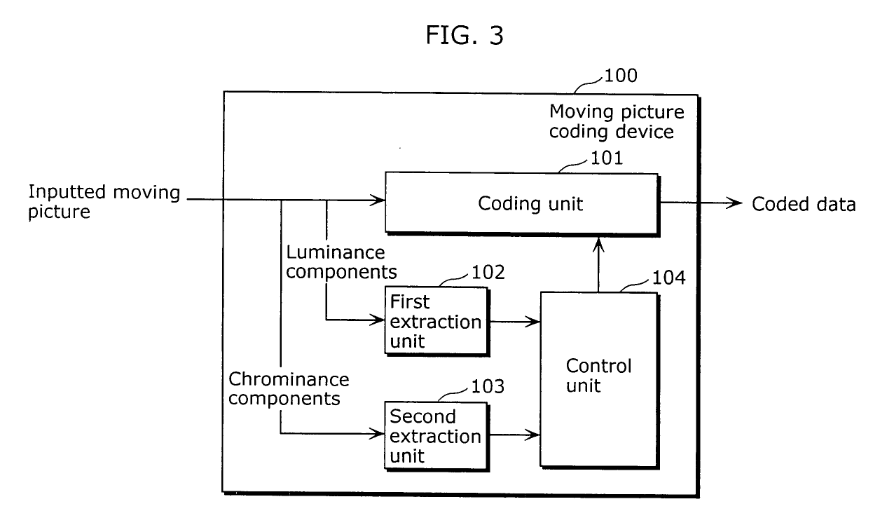

FIG. 3 is a structural diagram of a moving picture coding apparatus 100 in the first embodiment. The moving picture coding apparatus 100 is an apparatus that codes a moving picture, and functionally includes a coding unit 101, a first extraction unit 102, a second extraction unit 103 and a control unit 104. The coding unit 101 is a circuit, or the like, that compression-codes an inputted moving picture and outputs coded data. Formats such as MPEG2, MPEG4 and H.264 can be utilized as coding formats. The first extraction unit 102 is a circuit that extracts luminance components from the inputted moving picture, computes a feature quantity of the luminance components and outputs it. The second extraction unit 103 is a circuit that extracts chrominance components from the inputted moving picture, computes a feature quantity of the chrominance components and outputs it. Among the chrominance components, there are two types: blue chrominance components Cb and red chrominance components Cr, and so the second extraction unit 103 outputs feature quantities of these two types. The control unit 104 is a circuit that controls a parameter for the coding unit 101.

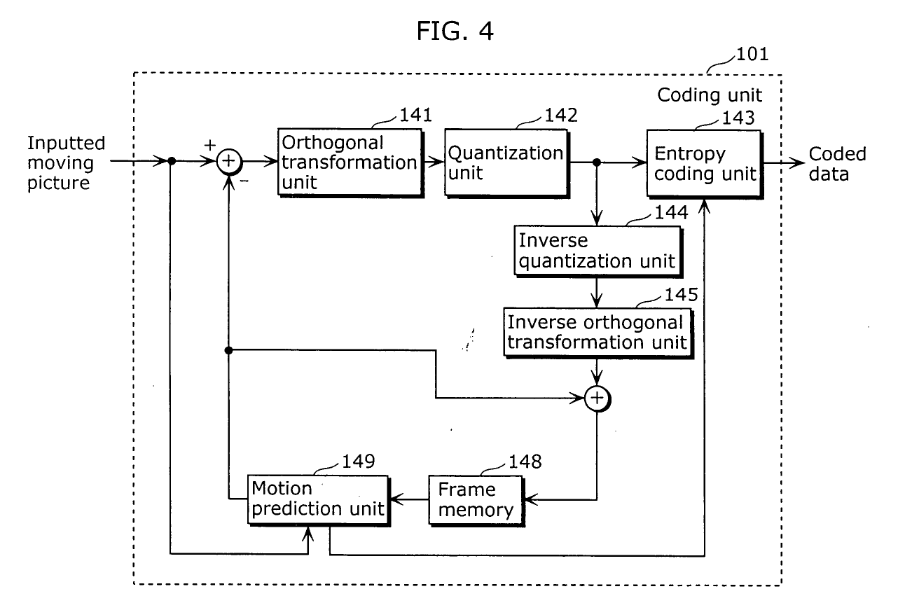

FIG. 4 is a structural diagram of the coding unit 101. As shown in the figure, the coding unit 101 includes an orthogonal transformation unit 141, a quantization unit 142, an entropy coding unit 143, an inverse quantization unit 144, an inverse orthogonal transformation unit 145, a frame memory 148, a motion prediction unit 149 and so on. The orthogonal transformation unit 141 is a circuit that orthogonally transforms the moving picture. The quantization unit 142 is a circuit that quantizes a value (data relating to the moving picture) which has been orthogonally transformed. The entropy coding unit 143 is a circuit that entropy codes the quantized value. The inverse quantization unit 144 is a circuit that inversely quantizes the quantized value. The inverse orthogonal transformation unit 145 is a circuit that orthogonally transforms the inversely quantized value. The frame memory 148 stores the inversely orthogonally transformed value. The motion prediction unit 149 is a circuit that estimates a motion vector for luminance components using the value stored in the frame memory 148, and implements a motion prediction. The moving picture coding apparatus 100 in the first embodiment utilizes a configuration which handles the motion vector for luminance and the motion vector for chrominance in common, in the same way as a typical moving picture coding apparatus.

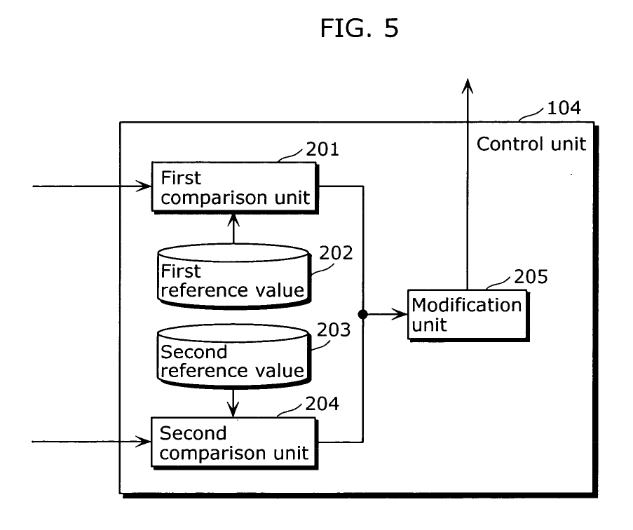

FIG. 5 is a structural diagram of the control unit 104. As shown in the diagram, the control unit 104 includes a first comparison unit 201, a second comparison unit 204, a first reference value 202, a second reference value 203 and a modification unit 205. The first comparison unit 201 compares the feature quantity of luminance components extracted by the first extraction unit 102 and the first reference value 202. The first reference value 202 is a value which indicates that the luminance is smooth. The second comparison unit 204 compares the feature quantity of chrominance components extracted by the second extraction unit 103, and the second reference value 203. The second reference value 203 is a value which expresses that there are variations in the chrominance. The modification unit 205 modifies a quantization width for the chrominance components based on the result of the comparison by the first comparison unit 201 and the result of the comparison by the second comparison unit 204.

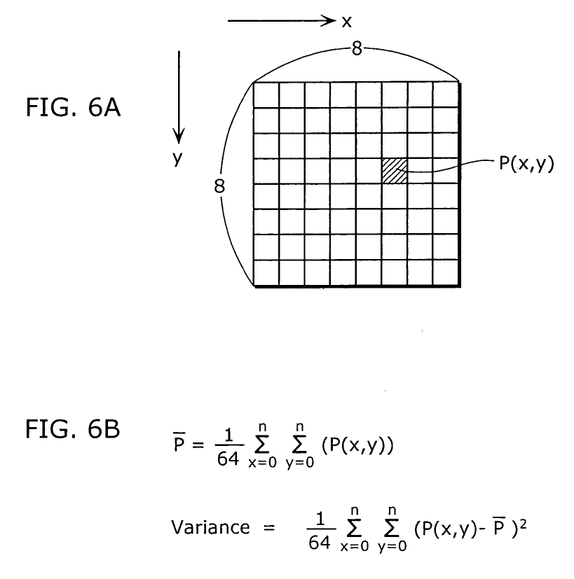

FIGS. 6A and 6B are explanatory diagrams of the feature quantity. As shown in FIG. 6A, a case is illustrated where a feature quantity of an 8×8 block is calculated, the feature quantity being data that indicates the features of luminance components and chrominance components as well as data for estimating when a color distortion occurs. When a color distortion seems likely to occur, the luminance components are smooth and there are variations in the chrominance components. When the luminance components are smooth, a variance of the luminance (below, referred to as “luminance variance”) in the pixels which compose the moving picture becomes smaller than the first reference value 202. Also, when there are variations in the chrominance components, a variance of the chrominance (below, referred to as “chrominance variance”) in pixels which compose the moving picture, becomes larger than the second reference value 203. In order to obtain a variance for the 8×8 pixel block, a pixel value P(x, y) among the XY coordinates should be substituted generally into a variance equation, as shown in FIG. 6B.

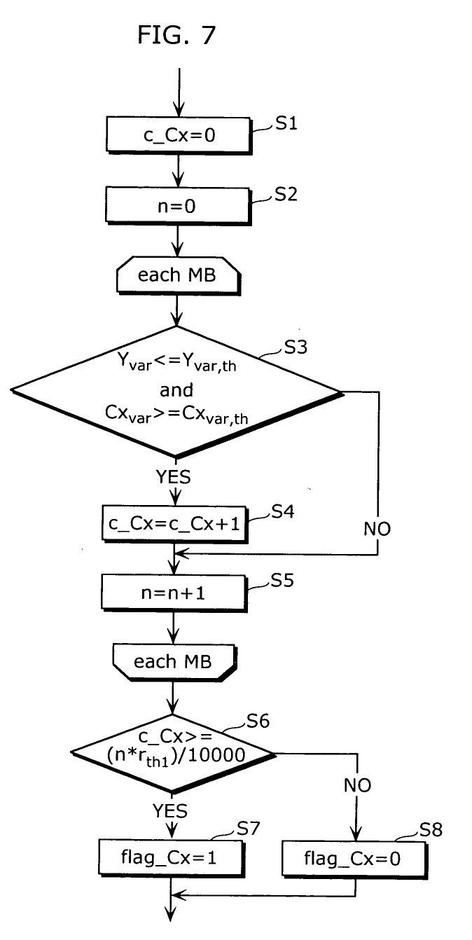

FIG. 7 is a flowchart which shows the operations of the moving picture coding apparatus 100 in the first embodiment. Here, the most distinctive operations of the control unit 104 are mainly described. The first extraction unit 102 divides the inputted moving picture into small areas such as 16×16 pixel macroblocks, computes a luminance variance for each divided small area and outputs it. In the same way, the second extraction unit 103 divides the inputted moving picture into small areas such as 8 pixel×8 pixel macroblocks, computes a chrominance variance for each divided small area and outputs it.

To begin with, the control unit 104 resets the variable number c_Cx to 0 (S1). The “x” of this variable number c_Cx is an identifier which stands for either the “b” of the blue chrominance components of Cb, or the “r” of the red chrominance components of Cr. This means, in other words, that the process shown in the flowchart applies to the blue chrominance components Cb and the red chrominance components Cr respectively.

Next, the control unit 104 resets the variable number n to 0 (S2).

Then, the control unit 104 repeats the processes below for each macroblock.

In other words, the control unit 104 compares the luminance variance Y_var in the macroblock, computed by the first extraction unit 102, and a first reference value Y_var,th. Additionally, the control unit 104 compares the chrominance variance Cx_var in the macroblock, computed by the second extraction unit 103, and the second reference value Cx_var,th. Then, when the luminance variance Y_var is less than or equal to the first reference value Y_var,th and the chrominance variance Cx_var is greater than or equal to the second reference value Cx_var,th (YES in S3), the variable number n is incremented by only 1 (S5) after the variable number c_Cx is incremented by only 1 (S4). Whereas, when the condition in Step S3 has not been fulfilled (NO in S3), the variable number n is incremented by only 1, without incrementing the variable number c_Cx (S5).

Next, the control unit 104 sets the variable number flag_Cx to 1 when the processing for the macroblocks in the picture finishes and when the variable number c_Cx is larger than or equal to (n×r_th1)/10,000 (YES in S6→S7). Whereas when the variable number c_Cx is less than (n×r_th1)/10,000, the control unit 104 sets the variable number flag_Cx to 0 (NO in S6→S8). The variable number c_Cx at this time stands for the number of macroblocks in one picture which fulfill the condition in step S3.

Next, the control unit 104 controls the quantization width for the chrominance components, based on the value of the variable number flag_Cx. In other words, when the variable number flag_Cx for the blue chrominance components Cb is 1, the quantization width for the blue chrominance components Cb is controlled so that it decreases to less than a predetermined quantization width. Whereas, when the variable number flag_Cx is 1 for the red chrominance components Cr, the quantization width for the red chrominance components Cr is controlled so that it decreases to less than the predetermined quantization width.

The predetermined quantization width is the default value for the quantization width prescribed in the H.264 standards. In the H.264 standards, the quantization width for the blue chrominance components Cb can be diminished by setting a negative value as an offset value chroma_qp_index_offset, or the quantization width for the red chrominance components Cr can be diminished by setting a negative value as an offset value second_chroma_qp_index_offset. In other words, in the main profile, it was only possible to control the quantization width for the blue chrominance components Cb and the red chrominance components Cr by bundling the quantization width for the blue chrominance components Cb and the red chrominance components Cr as a single process, however it becomes possible to control both separately by the addition of a high profile.

It is preferable to set the offset values chroma_qp_index_offset and second_chroma_qp_index_offset to −6 for example. In this way, the quantization width can be set to approximately half of the default quantization width. The value set as the offset value is not limited to a fixed value such as −6. For example, a function may be defined which returns a fluctuating value for the quantization width for the chrominance components based on the variance of luminance and the variance of chrominance. This function may be a piecewise linear approximation expression and may make reference to a table.

When the quantization unit 142 references the table for determining the quantization width for the chrominance components, a quantization process is performed for the chrominance components of the picture, using the offset values chroma_qp_index_offset, and second_chroma_qp_index_offset. For example, when −6 is set as the offset value chroma_qp_index_offset, a quantization process is performed for the blue chrominance components Cb by a quantization width of approximately half of the default value. Also, when −6 is set as the offset value second_chroma_qp_index_offset, a quantization process is performed for the red chrominance components Cr by a quantization width of approximately half of the default value.

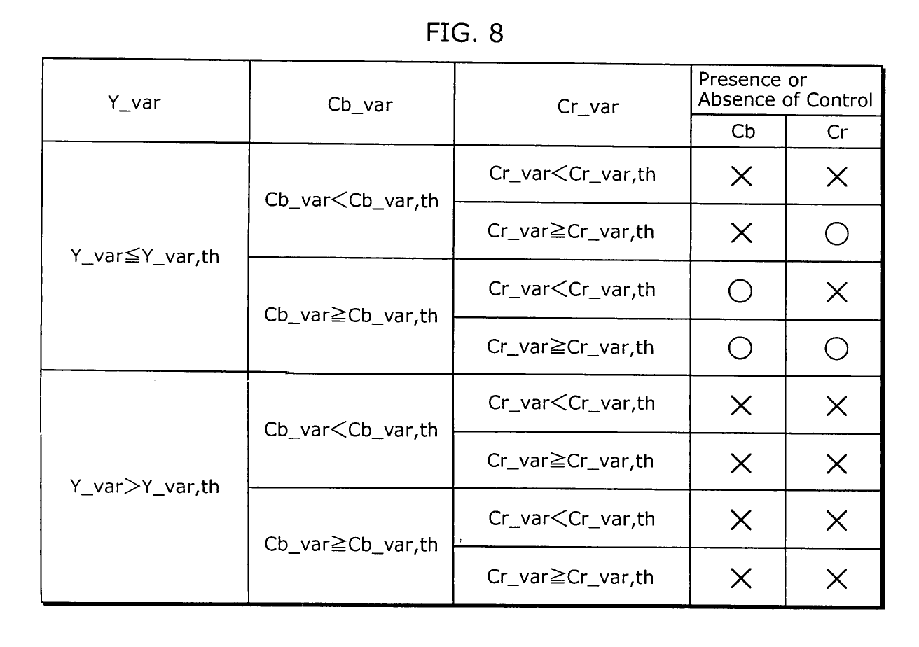

FIG. 8 is a diagram which shows that quantization widths for two types of chrominance components are controlled separately. The O symbol stands for the case where the quantization width is controlled, and the x symbol stands for the case where the quantization width is not controlled. As shown in the figure, the quantization width for the blue chrominance components Cb and the quantization width for the red chrominance components Cr are separately controlled. By doing so, the malfunction can be avoided where the quantization width for one of the chrominance components diminishes to the point of being unnecessary.

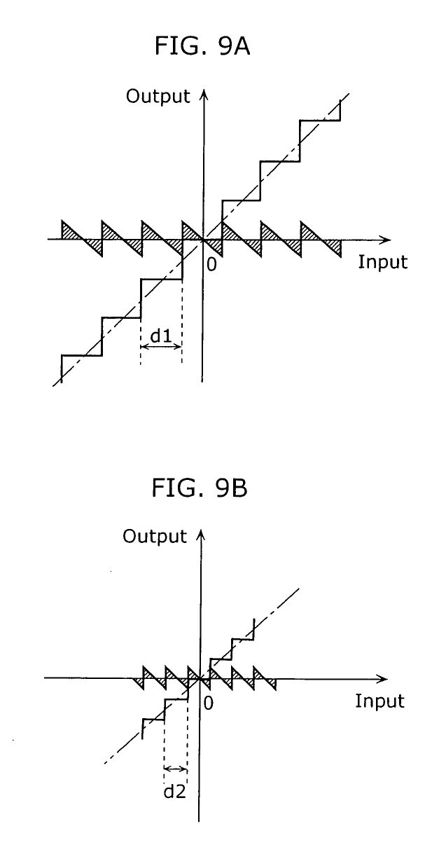

FIGS. 9A and 9B are figures which show an effect obtained by the first embodiment of the present invention. Specifically, FIG. 9A shows the input/output properties for quantization generally and FIG. 9B shows the input/output properties for the quantization in the first embodiment of the present invention. Lengths d1 and d2 correspond to the quantization width, and a cross-hatched portion corresponds to a quantization error. As already described, this quantization error is a cause of color distortion. According to the first embodiment of the present invention, the picture distortion problem can be avoided since the quantization error will diminish by exactly the same amount by which the quantization width diminishes when it diminishes to approximately half of its default value.

As above, the moving picture coding apparatus 100 in the first embodiment of the present invention can easily avoid the problem of color distortion. In other words, by merely adding a simple circuit for computing the luminance variance and the chrominance variance, the moving picture coding apparatus 100 can detect when color distortion will occur. With this, there is no need to add a complicated circuit necessary for motion estimation, as in the past, and the problems of strain on the memory band and of increases in consumed electricity are solved.

In the moving picture coding apparatus 100, the problem of color distortion can be avoided by diminishing the quantization width for the chrominance components. By doing so, the problem where the coding efficiency drops does not occur since there is no longer a need to use intra-frame coding, as there was in the past.

Moreover, according to the moving picture coding apparatus 100, since the quantization width for the blue chrominance components Cb and the quantization width for the red chrominance components Cr are separately controlled, the malfunction can be avoided in which the quantization width for only the chrominance components diminishes to the point of being unnecessary.

### Second Embodiment

In the first embodiment, the quantization width is controlled for every one picture, however it is normal for color distortion to occur across plural pictures. Therefore, in the second embodiment, a configuration is utilized which controls the quantization width for each of the plural and successive pictures. Below, the configuration of the moving picture coding apparatus 100 in the second embodiment is described for only the points which differ from the first embodiment.

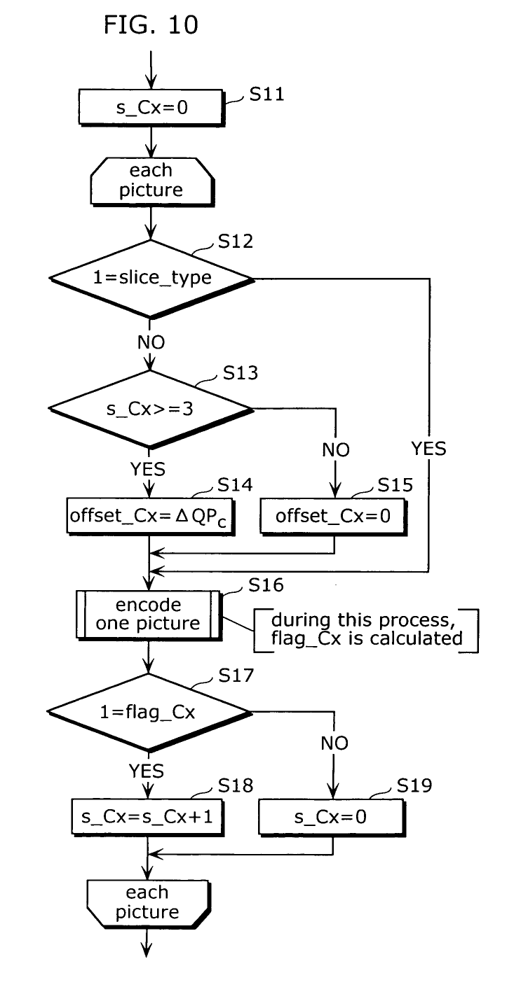

FIG. 10 is a flowchart which shows the operations of the moving picture coding apparatus 100 in the second embodiment. Here, the most distinctive operations of the control unit 104 are described centrally.

First, the control unit 104 resets a variable number s_Cx (S11). The “x” in this variable number s_Cx is an identifier which designates either the “b” in the blue chrominance components Cb, or the “r” in the red chrominance components Cr. In other words, this means that the process shown in the flowchart applies to each blue chrominance component Cb and each red chrominance component Cr, respectively.

Next, when the picture to be processed is an I picture or a P picture (NO in S12), the control unit 104 controls the quantization width for the chrominance components (S14) only when the variable number flag_Cx is 1 in a three picture succession (YES in S13). As described above, the value set as the offset value offset_Cx may be a fixed value such as −6 and may be a variable value Δ Q P c corresponding to the variance of luminance and the variance of chrominance; the control unit 104 holds the offset value set in this way. Subsequently, for a B picture (YES in S12), an offset value is set for an immediately preceding I picture or P picture.

Note that the control unit 104 calculates the value of the variable number flag_Cx according to a method described in the first embodiment, while the picture is being coded by the coding unit 101 (S16). The variable number s_Cx is then incremented by only 1 (YES in S17→S18) when the value of the variable number flag_Cx is 1, and the control unit 104 resets the variable number s_Cx to 0 when the variable number flag_Cx is 0 (NO in S17→S19), in preparation for a process for the pictures to follow.

As above and according to the second embodiment, the frequency with which the quantization width is modified in comparison to the first embodiment can be reduced since the quantization width for each of plural successive pictures is controlled. As mentioned above, the same result as the first embodiment can be obtained for avoiding the problem of color distortion even if the frequency, by which the quantization width is modified, is reduced, since it is normal for color distortion to occur across plural pictures. Here, the quantization width is controlled for every three pictures, however the number of pictures can be modified as appropriate according to the implementation of the present invention.

Note that in the descriptions above, feature quantities are extracted for the chrominance components of the two types Cb and Cr respectively, however one type of feature quantity may be extracted based on the two types of chrominance components Cb and Cr. In other words, data should be extracted which can detect when the luminance components will be smooth and the chrominance components will have variations; the number of feature quantities and the contents of each feature quantity is not limited.

Also, the first extraction unit 102 and the second extraction unit 103 are assumed to divide the input moving picture into small areas such as plural macroblocks, however the present invention is not limited thereto. In other words, the inputted moving picture may be divided into plural slices, and the same processes as above may be executed, without dividing the inputted moving picture into small areas. Of course, when the means for dividing the inputted moving picture into plural small areas are provided separately in the first extraction unit 102 and the second extraction unit 103, and these means input the small regions into the first extraction unit 102 and the second extraction unit 103, the same effect as above can be obtained.

Also, it is shown in FIG. 5 that the first reference value 202 is stored in a separate storage unit from the first comparison unit 201; however the same effect as above can be obtained even if the first comparison unit 201 holds the first reference value 202 as a set value. The same can be said for the second reference value 203.

In addition, a method to control the quantization matrix can be utilized according to H.264 and MPEG2. The control unit 104 may execute the same process as above utilizing the method which controls the quantization matrix.

The luminance variance is utilized as the feature quantity of the luminance components and the chrominance variance is utilized as the feature quantity of the chrominance components, however the present invention is not limited thereto. In the above embodiments, the absolute difference of the variance from the average luminance of the pixels which compose the moving picture may be utilized instead of the luminance variance. In the same way, the absolute difference of the variance from the average chrominance of the pixels which compose the moving picture may be utilized instead of the chrominance variance.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

As one example of an industrial application, the moving picture coding apparatus in the present invention can also be applied to applications which must smoothly avoid the problem of color distortion such as a DVD recorder.

What is claimed is:

1. A moving picture coding apparatus which codes a moving picture, said apparatus comprising:
a first extraction unit operable to extract a feature quantity of luminance components from the moving picture;
a second extraction unit operable to extract a feature quantity of chrominance components from the moving picture;
a first comparison unit operable to compare the extracted feature quantity of the luminance components with a first reference value;
a second comparison unit operable to compare the extracted feature quantity of the chrominance components with a second reference value;
a modification unit operable to modify a quantization width for the chrominance components based on the comparison by said first comparison unit and the comparison by said second comparison unit; and
a quantization unit operable to quantize information related to the moving picture utilizing the modified quantization width.

2. The moving picture coding apparatus according to claim 1,
wherein said modification unit is operable to decrease the quantization width for the chrominance components to less than a predetermined quantization width when the feature quantity of the luminance components is smaller than the first reference value and the feature quantity of the chrominance components is larger than the second reference value.

3. The moving picture coding apparatus according to claim 2,
wherein the predetermined quantization width is a default value prescribed in an H.264 standard.

4. The moving picture coding apparatus according to claim 1,
wherein said modification unit is operable to diminish the quantization width for the chrominance components to less than a predetermined quantization width when the feature quantity of the luminance components for a plurality of successive pictures is smaller than the first reference value and the feature quantity of the chrominance components for a plurality of successive pictures is larger than the second reference value.

5. The moving picture coding apparatus according to claim 1,
wherein said modification unit is operable to diminish the quantization width for the chrominance components to less than a predetermined quantization width when the moving picture is one of an I picture and a P picture.

6. The moving picture coding apparatus according to claim 1,
wherein said first extraction unit is operable to extract the feature quantity of the luminance components for each of a plurality of areas that composes the moving picture;
said second extraction unit is operable to extract the feature quantity of the chrominance components for each of the plurality of areas which composes the moving picture; and
said modification unit is operable to modify the quantization width for each of the plurality of areas.

7. The moving picture coding apparatus according to claim 1,
wherein the feature quantity of the luminance components is one of a variance of luminance in pixels which compose the moving picture and a sum of absolute differences of variances from an average luminance in the pixels which compose the moving picture.

8. The moving picture coding apparatus according to claim 1,
wherein the feature quantity of the chrominance components is one of a variance of chrominance in pixels which compose the moving picture and a sum of absolute differences of variances from an average chrominance in the pixels which compose the moving picture.

9. The moving picture coding apparatus according to claim 1,
wherein the first reference value is a value which indicates that the luminance of the moving picture is smooth, and the second reference value indicates that there are variations in the chrominance of the moving picture.

10. A moving picture coding method which codes a moving picture, said method comprising:
extracting a feature quantity of luminance components from the moving picture;
extracting a feature quantity of chrominance components from the moving picture;
comparing the extracted feature quantity of the luminance components with a first reference value;
comparing the extracted feature quantity of the chrominance components with a second reference value;
modifying a quantization width for the chrominance components based on said comparing the extracted feature quantity of the luminance components with the first reference value and comparing the extracted feature quantity of the chrominance components with the second reference value; and
quantizing information related to the moving picture utilizing the modified quantization width.

11. The moving picture coding method according to claim 10,
wherein said modifying includes decreasing the quantization width for the chrominance components to less than a predetermined quantization width when the feature quantity of the luminance components is smaller than the first reference value and the feature quantity of the chrominance components is larger than the second reference value.

12. A computer-executable program for coding a moving picture, said computer-executable program comprising:
a computer-executable program code operable to cause a computer to:
extract a feature quantity of luminance components from the moving picture;
extract a feature quantity of chrominance components from the moving picture;
compare the extracted feature quantity of the luminance components with a first reference value;
compare the extracted feature quantity of the chrominance components with a second reference value;
modify a quantization width for the chrominance components based on the comparing of the extracted feature quantity of the luminance components with the first reference value and the comparing of the feature quantity of the extracted chrominance components with the second reference value; and
quantize information related to the moving picture utilizing the modified quantization width.

13. The computer-executable program according to claim 12,
wherein the modifying includes diminishing the quantization width for the chrominance components to less than a predetermined quantization width when the feature quantity of the luminance components is smaller than the first reference value and the feature quantity of the chrominance components is larger than the second reference value.

14. An integrated circuit which codes a moving picture, said integrated circuit comprising:
a first extraction unit operable to extract a feature quantity of luminance components from the moving picture;
a second extraction unit operable to extract a feature quantity of chrominance components from the moving picture;
a first comparison unit operable to compare the extracted feature quantity of the luminance components with a first reference value;
a second comparison unit operable to compare the extracted feature quantity of the chrominance components with a second reference value;
a modification unit operable to modify a quantization width for the chrominance components based on the comparison by said first comparison unit and the comparison by said second comparison unit; and
a quantization unit operable to quantize information related to the moving picture utilizing the modified quantization width.

15. The integrated circuit according to claim 14,
wherein said modification unit is operable to decrease the quantization width for the chrominance components to less than a predetermined quantization width when the feature quantity of the luminance components is smaller than the first reference value and the feature quantity of the chrominance components is larger than the second reference value.

16. A moving picture coding apparatus which codes a moving picture, said apparatus comprising:
a luminance extraction unit operable to extract a feature quantity of luminance components from the moving picture, the feature quantity of the luminance components being one of a variance of luminance in pixels which compose the moving picture and a sum of absolute differences of variances from an average luminance in the pixels which compose the moving picture;
a chrominance extraction unit operable to extract a feature quantity of chrominance components from the moving picture, the feature quantity of the chrominance components being one of a variance of chrominance in pixels which compose the moving picture and a sum of absolute differences of variances from an average chrominance in the pixels which compose the moving picture;
a control unit operable to:
compare the extracted feature quantity of the luminance components with a first reference value;
compare the extracted feature quantity of the chrominance components with a second reference value; and
modify a quantization width for the chrominance components based on the comparison of the extracted feature quantity of the luminance components with the first reference value and the comparison of the extracted feature quantity of the chrominance components with the second reference value; and
a quantization unit operable to quantize information related to the moving picture utilizing the modified quantization width.

17. The moving picture coding apparatus according to claim 16,
wherein said control unit is operable to decrease the quantization width for the chrominance components to less than a predetermined quantization width when the feature quantity of the luminance components is smaller than the first reference value and the feature quantity of the chrominance components is larger than the second reference value.

18. The moving picture coding apparatus according to claim 16, wherein said moving picture coding apparatus utilizes one of MPEG-2, MPEG-4 and H.264 as a coding format.

19. The moving picture coding apparatus according to claim 16, wherein said moving picture coding apparatus is provided in a DVD recorder.
